(19) United States
(12) Patent Application Publication
(10) Pub. No.: US 2001/0014975 A1
(43) Pub. Date: Aug. 16, 2001

(54) TRANSMITTING VIEWABLE DATA OBJECTS

(75) Inventors: YVETTE MARIE GORDON, ORLANDO, FL (US); ALAN RICHARD LATHROP, LITTLETON, MA (US)

Correspondence Address: GARY A WALPERT, FISH & RICHARDSON, 225 FRANKLIN STREET, BOSTON, MA, 021102804

(73) Assignee: SEACHANGE INTERNATIONAL , INC.

(21) Appl. No.: 09/293,011

(22) Filed: Apr. 16, 1999

(51) Int. Cl. G06F 15/16; H04N 7/173

(52) U.S. Cl. 725/91

(57) ABSTRACT

A network transmits viewable data objects to viewer receivers. The network includes a plurality of local servers to store subsets of the viewable data objects, a plurality of links to couple each local server to a set of viewer receivers without coupling the viewer receivers together, and at least, one storage server. Each local server transmits viewable data objects to viewer receivers. The storage server stores the viewable data objects and transmits a subset of the stored data objects to the local servers responsive to different expected demands there present.

### BACKGROUND OF THE INVENTION

This application relates generally to video and data transmission networks, and more particularly, to distributed networks, which transmit viewable data objects to viewers.

One type of transmission network is an interactive television network. An interactive television network displays a video data object on a viewer's television in response to receiving the viewer's request for the object. The viewer sends requests for data objects using his television's digital settop box. The digital settop box and television also allow the viewer to browse network libraries for videos, which can then be requested. Thus, an interactive television network both receives requests from and transmits video, graphics, and text objects to viewers' televisions.

A conventional interactive transmission network is similar to an internet video data base. Both the internet video data base and conventional interactive transmission network use servers to store video objects. In each case, the servers have large data storages to accommodate a library of video objects. In each case, viewers request and receive the video objects over a network. In each case, the data objects are large and different objects may be requested simultaneously. Thus, the networks either have large bandwidths or transmit video objects slowly. Large data storage and bandwidth requirements make interactive television networks expensive to operate.

The present invention is directed to overcoming or, at least, reducing the effects of one or more of the problems set forth above.

One objective is to use less data storage in an interactive transmission system for data objects.

Another objective is to manage transport bandwidth usage in an interactive transmission system for data objects.

Another objective is to distribute viewable data objects in an interactive transmission network based on viewing trends, events, and predetermined priorities.

Another objective is to automate the distribution of viewable data objects in an interactive transmission network.

For example, the network may automate state changes for data objects in the network.

Another objective is to implement one or more of the above objectives in an interactive television network.

### SUMMARY OF THE INVENTION

In a first aspect, the invention provides a network for transmitting viewable data objects to viewer receivers. The network includes a plurality of local servers to store subsets of the viewable data objects, a plurality of links to couple each local server to a set of viewer receivers without coupling the viewer receivers together, and at least, one storage server. Each local server transmits viewable data objects to viewer receivers. The storage server stores the viewable data objects and transmits a subset of the stored data objects to the local servers responsive to different expected demands there present.

In a second aspect, the invention provides a network for transmitting viewable data objects interactively. The network includes a plurality of local servers to store subsets of the viewable data objects, a plurality of lines to couple each local server to a set of viewer receivers without coupling viewer receivers together, and at least one storage server. Each local server transmits a viewable data object to a viewer receiver in response to receiving a request therefrom. The storage server stores the viewable data objects and transmits a subset of the stored data objects to the local servers responsive to different expected demands there present.

In a third aspect, the invention provides a cable television network. In addition to allowing users to browse network channels, the cable television network includes a plurality of local servers to transmit other viewable data objects to different viewer televisions or settop boxes and a device to transmit viewable data objects to each of the local servers. Each server transmits a viewable data object to a television or settop box for viewing in response to a request from the television. The device is able to transmit different viewable data objects to the different local servers.

In a fourth aspect, the invention provides a method of transmitting viewable data objects to viewer receivers. The method includes selecting a first viewable data object from a pool of viewable data objects in response to a preselected event, selecting a second viewable data object from the pool in response to the preselected event, and transmitting the first and second objects to respective first and second local servers. The first and second objects are responsive to different priorities of the respective first and second local servers for data object content. The method also includes sending a data object from the first local server to a first viewer receiver and sending a data object from the second local server to a second viewer receiver.

### BRIEF DESCRIPTION OF THE DRAWINGS

Other objects, features, and advantages of the invention will be apparent from the following description taken together with the drawings, in which:

FIG. 1 schematically illustrates a system for transmitting viewable data objects to viewer receivers;

FIG. 2 illustrates a viewer receiver to an interactive television network;

FIG. 3 illustrates an interactive embodiment of the transmission system of FIG. 1;

FIG. 4A illustrates one storage server of the distribution network of FIG. 3;

FIG. 4B illustrates one local server of the distribution network of FIG. 3;

FIG. 5A is a flow chart illustrating a method of transmitting data objects through the network of FIG. 3 interactively;

FIG. 5B is a flow chart illustrating a master-slave method for distributing data objects in the network of FIG. 3;

FIG. 5C is a flow chart illustrating a shared control method for distributing data objects in the network of FIG. 3; and

FIG. 6 is a flow chart illustrating a method for handling a viewer request for a data object in the system of FIG. 3.

### DESCRIPTION OF THE PREFERRED EMBODIMENTS

In the following, several defined terms will be used.

An event is a specific occurrence, date, or time, which triggers a state change of a viewable data object on a network. For example, 7 pm is an event, if this time can cause a storage server to transmit a viewable data object for a news clip to local servers of the network.

A group is a set of related viewable data objects, which can be transmitted, stored and/or deleted as a unit. For example, a group may include a video object for a film, an image object publicizing the film, and a text object reviewing the film.

Meta data is data associated with a single video data object. A network may transmit meta data to help a viewer determine whether to request the associated viewable data objects. For example, meta data for a video may be a genre, title, actor/director names, and/or a viewing price. News clip meta data may include broadcast date and/or topic. Game meta data may include a name, an age range, and/or player ratings.

One or more priorities are associated with each viewable data object and/or each local server. If conflicts occur in network bandwidth and/or storage usage, network components resolve the conflicts by performing actions consistent with the relevant priorities. Priorities may be fixed or dynamical. Dynamical priorities may change in response to a preselected event and/or a control signal from a network manager. Priorities may be based on events, viewing trends, revenue potential, and/or composition of viewers.

States are stages in the life of a single viewable data object on a transmission system. The states may include licensed to network, acquired by network, prepared for distribution to network, stored on storage servers, loaded on local servers, encoded at local servers, activated at local servers, being viewed, deactivated on local servers, and/or deleted from local servers.

Viewable data objects are sets of data files that automatically execute on a viewer's receiver. Viewable data objects may include data files for broadcasts, videos, audio recordings, images, games, text, and/or shopping interfaces. For example, the content of a video viewable data object may be a half-hour television show, a movie, a film clip, and/or a news clip.

A viewer is a person with a receiver.

A viewer receiver is a device for requesting data objects from a network, receiving the requested data objects, and displaying the received data objects.

Viewer Statistics is data on viewing of individual or sets of viewable data objects. The system may use viewer statistics to determine viewing trends and to bill viewers.

Viewing is the process of using a viewable data object on a viewer's network receiver. Depending on the type of viewable data object, viewing may include visual, auditory, and/or interactive activities by the viewer. For example, a video object is viewed visually, but a game object is viewed interactively by playing the game.

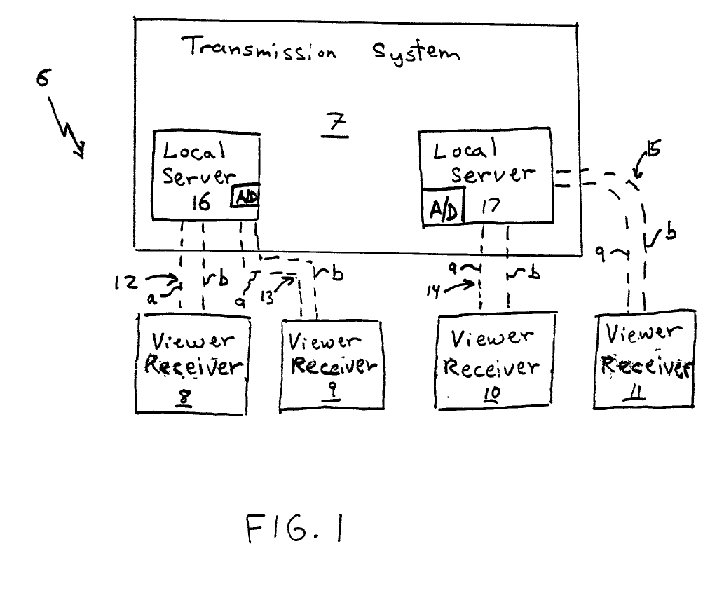

FIG. 1 illustrates a system 6 for viewing data objects. The system 6 includes a transmission system 7 and viewer receivers 8-11. The transmission system 7 transmits viewable data objects for storage in local servers 16, 17. The local servers 16, 17 can transmit viewable data objects to a plurality of the viewer receivers 8-11. The various viewer interfaces 8-11 may access different sets of viewable data objects, because each receiver 8-11 only accesses one local server 16, 17 and the local servers 16, 17 may store different viewable data objects. The viewer receivers 8-11 cannot communicate with each other either through the system 7 or the local servers 16, 17.

In some embodiments, the system 6 is interactive and can receive viewer commands from, preferably, the viewer receivers 8-11. The viewer commands request video data objects and/or control streaming of the viewable data objects received.

In interactive embodiments, each local server 16, 17 couples to the viewer receivers 8-11 through links 12-15, for example, cable lines, having first and second channels “a” and “b”. The channels “a” have high bandwidths for sending large viewable data objects to the receivers 8-11. The channels “b” have low bandwidths for sending viewer commands and viewing statistics to the local servers 16, 17 from the receivers 8-11.

In a specific interactive embodiment, the transmission system 7 may provide viewers with interactive television. Then, the receivers 8-11 are interactive televisions and the links 12-15 may be, for example, hybrid fiber coaxial lines or satellite links. The local servers 16, 17 may also include analog to digital converters (A/D) to convert the viewable data objects to an analog form if the viewer receivers 8-11 are analog televisions.

In another interactive embodiment, the transmission system 7 is a cable modem deployment, and the viewer receivers 8-11 are personal computers interacting with the deployment network through modems (not illustrated).

The present invention covers, but is not limited to these interactive embodiments.

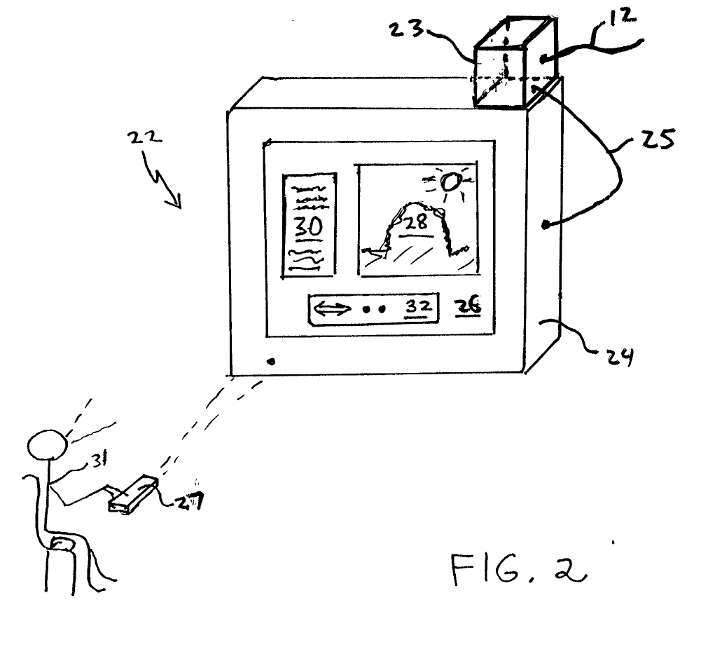

FIG. 2 illustrates an interactive embodiment 22 of the viewer receiver 8 of the system 7 of FIG. 1. The viewer receiver 22 includes a settop box 23, a television 24 and a controller 26.

The settop box 23 receives viewable data objects from the network link 12, converts the objects to displayable form, and transmits the converted objects to the television 24 via line 25. For example, the conversion may be from digital to analog form or may involve other modifications enabling the received object to be displayed by the particular viewer television 24. Some televisions may have an internal device (not shown) for performing the function of the settop box 23.

The television 24 has a screen 26 to display viewable data objects. The screen 26 may display a single viewable data object (not illustrated) on its entire viewable surface or several viewable data objects 28, 30 simultaneously on different portions of the surface. The objects 28, 30 may belong to a single group, such as a film and a textual critique of the film, or to different groups, such as a requested film and an image for an unrelated advertisement. The displayed data object 30 may also provide meta data, such as the price for viewing the data object 28 to a viewer 31 who subscribes to the interactive television service provided by the system 7. The screen 26 may include a bar 32 for displaying data on displayed objects 28, 30 and/or for controlling the displayed object 28, 30.

The bar 32 allows a viewer 31 to view streaming times and to send commands for controlling the streaming of the displayed objects 28, 30. These commands may include pausing, resuming, fast forwarding, and rewinding the streaming object 28 if the object 28 is a video, an audio recording, and/or a game. Some commands may also implement recoveries from streaming failures, which can occur during transmission. Viewer commands and requests for viewable data objects are sent to the settop box 23, which converts them to forms transmittable to the transmission system 7 via the line 12.

The local servers 16, 17 may selectively restrict viewer access to streaming controls based on parameters such as content, locality, type of data object, and/or to events. Such restrictions may be imposed for a variety of reasons. Restricting access to rewind may enable the distribution of data objects on a pay per view basis. For example, access to game data objects is generally only possible, on a pay per view basis, if the game cannot be rewound and/or restarted by a viewer. Restricting access to fast forward enables commercial advertisements to be embedded into data objects, because this restriction stops viewers from fast forwarding through advertisements. Restricting access to pause and/or rewind may also be used to ensure that a viewing session terminates within a predetermined time.

The transmission system 7 receives and processes these viewer commands to perform the requested actions on the streaming data objects 28, 30. The local servers 16, 17 may support processing the commands in a limited fashion, for example, to not allow a viewer to fast forward through advertisements.

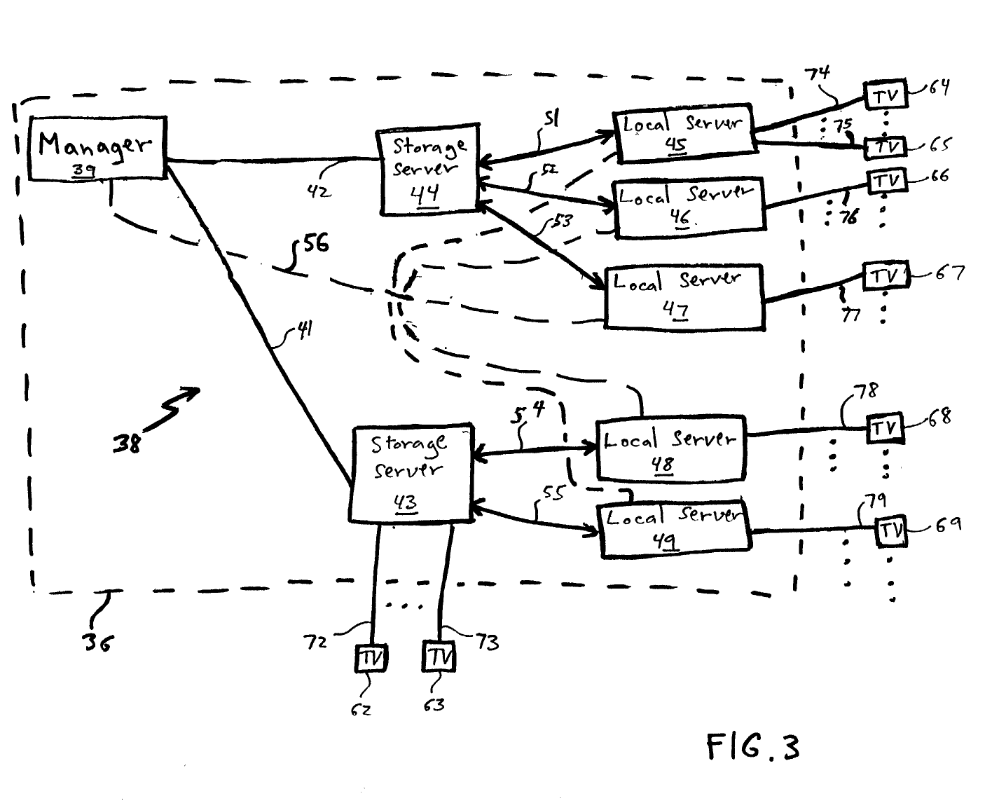

FIG. 3 illustrates an embodiment 36 of the transmission system 7, illustrated in FIG. 1. The transmission system 36 provides interactive television to viewers. The transmission system 36 includes a distribution network 38 for transmitting viewable data objects to viewers and an automated network manager 39 to control the distribution network 38. The distribution network 38 has local servers 45-49 and storage servers 43-44. The manager 39 couples to individual ones of the storage servers 43, 44 through the lines 41, 42. Each storage server 43, 44 directly couples to a subset of the local servers 45-49 via lines 51-55. The lines 51-55 transmit viewable data objects from the storage servers 43, 44 to the local servers 45-49. The lines 51-55 may also transmit viewer statistics and operations data from the local servers 45-49 to the storage servers 43, 44. The number of local and storage servers 43-49 is inessential, but there are generally many local servers 45-49 for each storage server 43, 44.

Each local server 45-49 connects to a plurality of viewer televisions 64-69 through links 74-79. Each local server 45-49 transmits viewable data objects to a local set of televisions 64-69 and also receives commands from the same local set of televisions 64-69. But, both the storage and the local servers 43-49 do not support transmissions between the televisions 64-69. Furthermore, the local servers 45-49 do not need to communicate with each other, and the storage servers 43-44 do not need to communicate with each other.

As FIG. 3 illustrates, a storage server 43 may transmit viewable data objects directly to a subset of the televisions 62-63. With respect to these televisions 62-63, the storage server 43 acts as a local server.

The manager 39 controls the network 38 and the states of the viewable data objects. The manager 39 transmits new viewable data objects and associated meta data to the storage servers 43, 44 via the lines 41, 42. Each viewable data object may contain a deactivation time readable and executable by the servers 43-49. The servers 43-49 transmit viewing statistics to the manager 39 for use in billing viewers and in evaluating priorities and prices assigned to the viewable data objects. The manager 39 may also transmit to the servers 43, 44 viewable data objects to announce upcoming viewable data objects to viewers.

The manager 39 may propagate other data through the storage servers 43, 44 or directly to the local servers 4549 via an independent line 56. This data includes meta data on distributed viewable data objects, for example, viewing prices, and upgrades to game software. The servers 43-49 incorporate this data in the data objects and into the menu transmitted to the televisions 62-69 to announce available viewable data objects. The data may be state data announcing dates for licensing, distributing, and deleting upcoming and distributed viewable data objects. The state data may be incorporated, by the servers 43-49, into the menu of viewable data objects sent to the viewer televisions 62-69.

The manager 39 may centrally control the states of the viewable data objects on the storage servers and/or the local servers 43,-44, 45-47. In particular, the manager 39 may automate work queues that change the states of viewable data objects on the individual local servers 45-47. These automated state changes may include: digitalizing, preprocessing and encoding, quality testing, transporting between storage and local servers 43-49, loading onto servers, activating and deactivating for viewing, and deleting. The manager 39 may automate the work queues for the data objects centrally or may simply send regular schedules for processing the various data objects to the servers 43-44, 45-49 so that the network 38 is centrally organized.

Each storage server 43, 44 is a mass storage of viewable data objects for the local servers 45-49 coupled thereto. The storage servers 43, 44 can receive from the manager 39 and transmit to the local servers 45-49 different viewable objects if expected or actual viewer demands to the different storage and/or local servers 43-49 are different.

The viewer televisions access only data objects on the server or servers 43-49 connected to the viewer's television 62-69. This lowers network traffic below traffic levels in networks (not illustrated) allowing viewers to access any server and to communicate with other viewers. The local servers 45-49 have less storage, because the storage servers 43, 44 transmit data objects to the local servers 45-49 as needed. If the local servers 45-49 are numerous and the storage servers 43, 44 are neither too numerous nor too large, the network 38 uses less storage hardware than a network (not illustrated) without storage servers.

According to the invention, viewer access is limited to the server 45-49 connected to the viewer. Thus, a delay may occur between a request and fulfillment of the request, because the requested data object is not on the server 45-49 connected to the viewer. The local servers 45-49 can inform a viewer of such availability delays for a requested viewable data objects not currently stored thereon.

In some embodiments, the network 38 has a geographical organization in which separate geographical regions have separate storage servers 43, 44. A viewer in one region receives viewable data objects from that local server 45-49 assigned to the viewer's portion of the region. That local server receives its viewable data objects from the region's associated storage server, that is the server 43 or the server 44 in the illustrated embodiment of FIG. 3.

The illustrated network 38 is a star-shaped cable network and may be, for example, a hybrid-fiber-coaxial network (HFCN). In an HFCN, the storage servers 43, 44 act as hubs between the lines 41, 42 and the lines 51-55 and the local servers 45-49 act as headends of the lines 51-55. In an HFCN, the links 72-79 may be hybrid-coaxial fibers, coaxial lines, and the lines 41-42, 51-55 may be optical fibers. Each of the lines 41, 42, 51-55 and links 72-79 can employ separate high and low bandwidth channels with the high bandwidth channels adapted to transmit the viewable data objects.

Some embodiments of the network 38 have other structural configurations and may have several levels of storage servers. The network 38 may include a higher layer of storage servers (not illustrated) for supplying local groups of storage servers, e.g., one higher level storage server may supply the storage servers 43, 44.

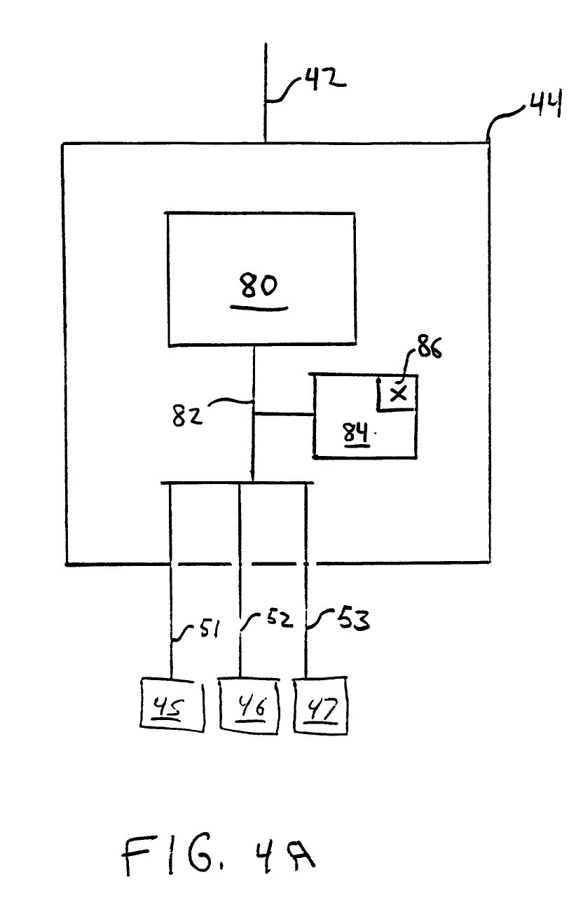

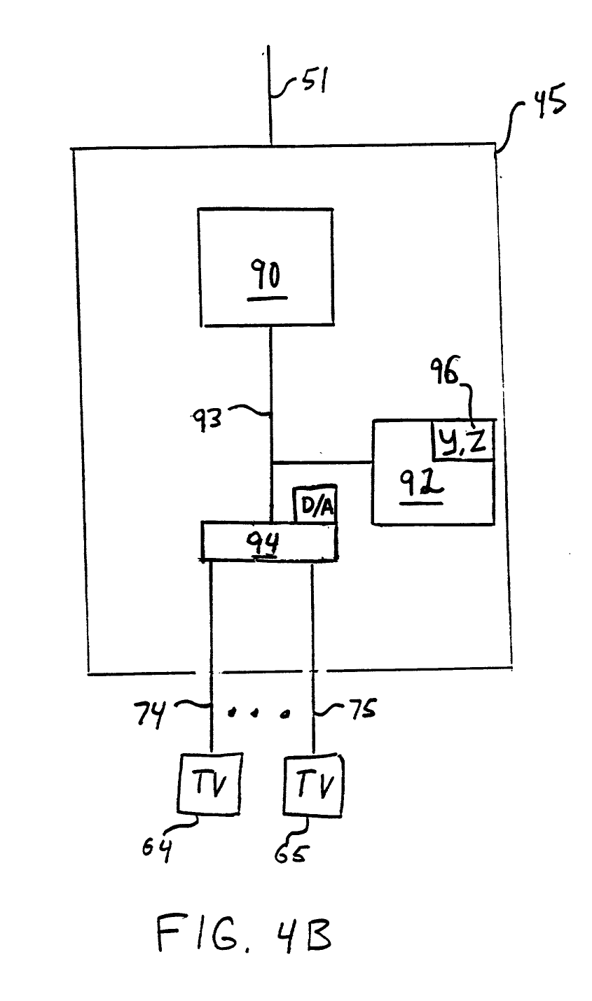

The various storage servers 43, 44 have similar constructions. FIG. 4A illustrates, for example, the storage server 44 of FIG. 3. The storage server 44 has a large capacity storage device 80, for example, an array of disks, to store viewable data objects received from the manager 39. The storage device 80 transmits stored data objects to a bus 82. The bus 82 also couples to the local servers 45-47 via the lines 51-53. The bus 82 has a processor 84 to control transmissions from the storage device 80 to the local servers 45-47. The processor 84 has hardware or a software program stored in a memory 86 to control transmissions of viewable data objects to the local servers 45-47. The processor 84 can be programmed from the manager 39 according to some embodiments of the invention.

The different local servers 45-49 have similar constructions. FIG. 4B illustrates, for example, the local server 45 of FIG. 3. The local server 45 has a device 90 for storing viewable data objects. A processor 92 controls transmissions of viewable data objects from the storage device 90 to a bus 93 also connecting to a receiver 94 coupled to the televisions 64, 65. The receiver 94 may include a digital to analog converter (D/A) if the televisions 64, 65 require analog forms of the viewable data objects as opposed to the digital forms stored in the device 90. The processor 92 receives commands and viewing statistics from the televisions 64-65 via the receiver 94 and the bus 93. The processor 92 also transmits viewing statistics and operations data to the storage server 44. The processor 92 has control hardware or programs designated “Y” and “Z” stored in a memory 96.

The programs designated “Y” and “Z” or hardware (not illustrated) control writes and stores of viewable data objects. The program “Y” controls viewer requested writes over the bus 93 of data objects stored in the storage device 90. The program “Z” determines whether a data object received from the storage server 44, over the line 51, should be stored to the device 90 or discarded. The determination is based on priorities and/or events. The received object, the objects already stored in the device 90, and the local server 45 may all have priority ratings used to determine whether to store or discard the received object. Some embodiments also use the program “Z” to request data objects from the storage server 44.

The servers 43-49 have intelligence to resolve conflicts appearing during the transmission and storage of viewable data objects to the local servers 45-49. The intelligence may reside in either the local servers 45-49, the storage servers 43, 44, and/or the manager 39. The processor 92 and/or the processor 80 implement the intelligence. The intelligence transmits and stores data objects to the local servers 45-49 in response to expected and actual viewer requests.

The intelligence also resolves conflicts based on priorities and events. The intelligence may use both system-wide and local server-specific priorities. For example, the system-wide priorities may be based on the popularity of events such as sports matches, broadcasts and/or of games. The local-server specific priorities may be based on the composition of viewers served by each local server 45-49. For example, a higher priority may be given to Spanish language data objects at those local servers 45-49 serving areas with higher populations of Hispanic Americans. The intelligence may also use priorities of data objects based on revenue optimization. For example, the priority of a data object for a sporting event may be increased if viewers are more willing to pay to view the sporting event.

The intelligence may give higher priorities to viewable data objects during preselected events. For example, the intelligence may give higher priorities to children's cartoons on weekends and to action movies during evenings. The intelligence may also distribute news and sports broadcasts in response to special occurrences.

The intelligence may also transmit viewable data objects based on available and upcoming space and bandwidth. For example, a transmission may start in response to the deactivation of a data object or to the completion of present viewings of a data object already stored at a target local server 45-49. The local servers 45-49 may transmit operations data regarding the stored data objects and the viewing completion times to the storage servers 43, 44 for use in upcoming space and bandwidth determinations.

Finally, the intelligence may distribute viewable data objects based on requests from the televisions 64-69. For example, a request from one of the televisions 64-65 may trigger the storage server 44 to transmit the requested data object to the local server 45. The local servers 45-49 may also collect viewing statistics for use by the system 36 to predict expected viewing demands. Thus, viewing trends may provide feedback to the intelligence.

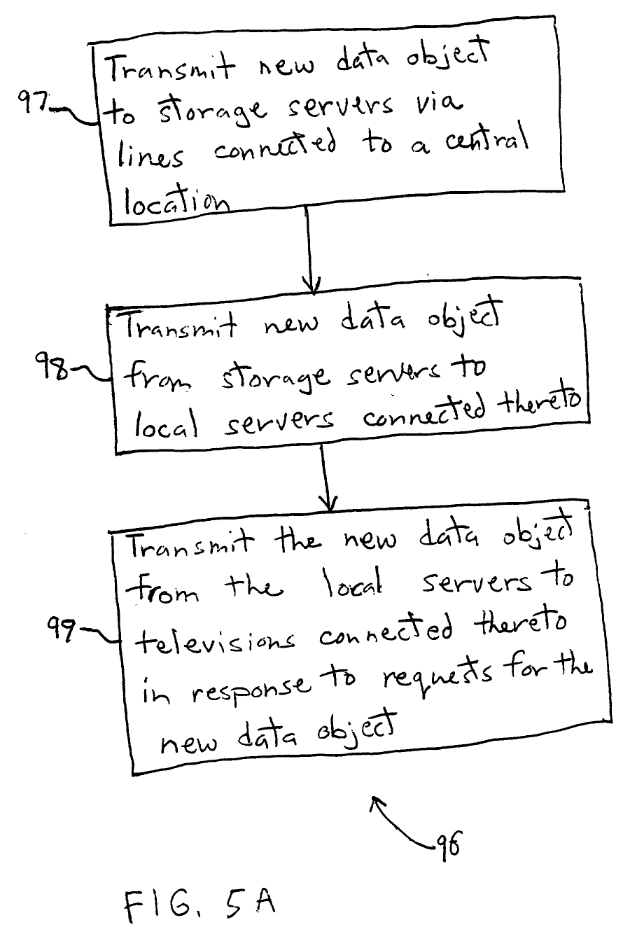

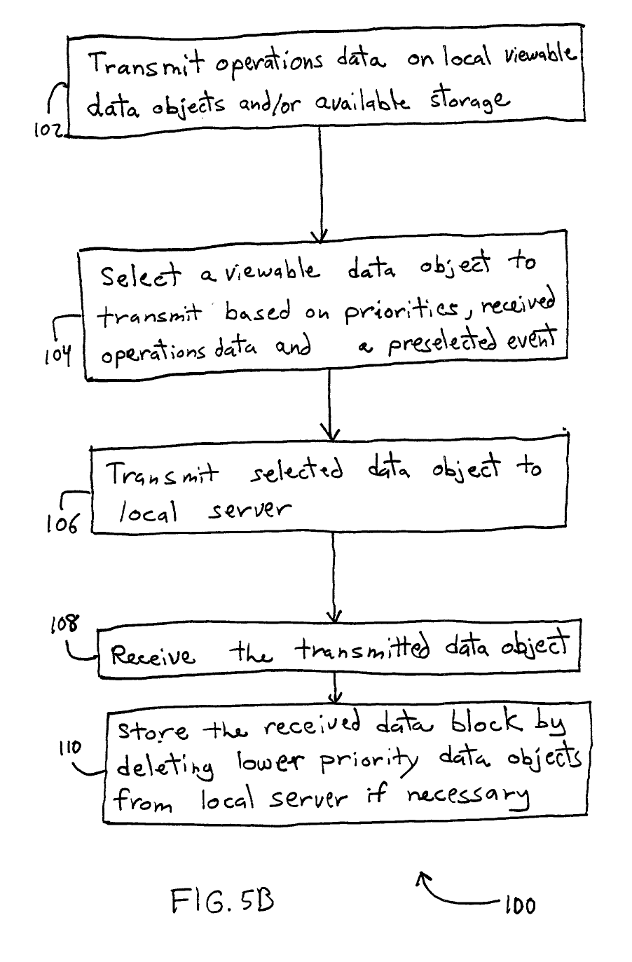

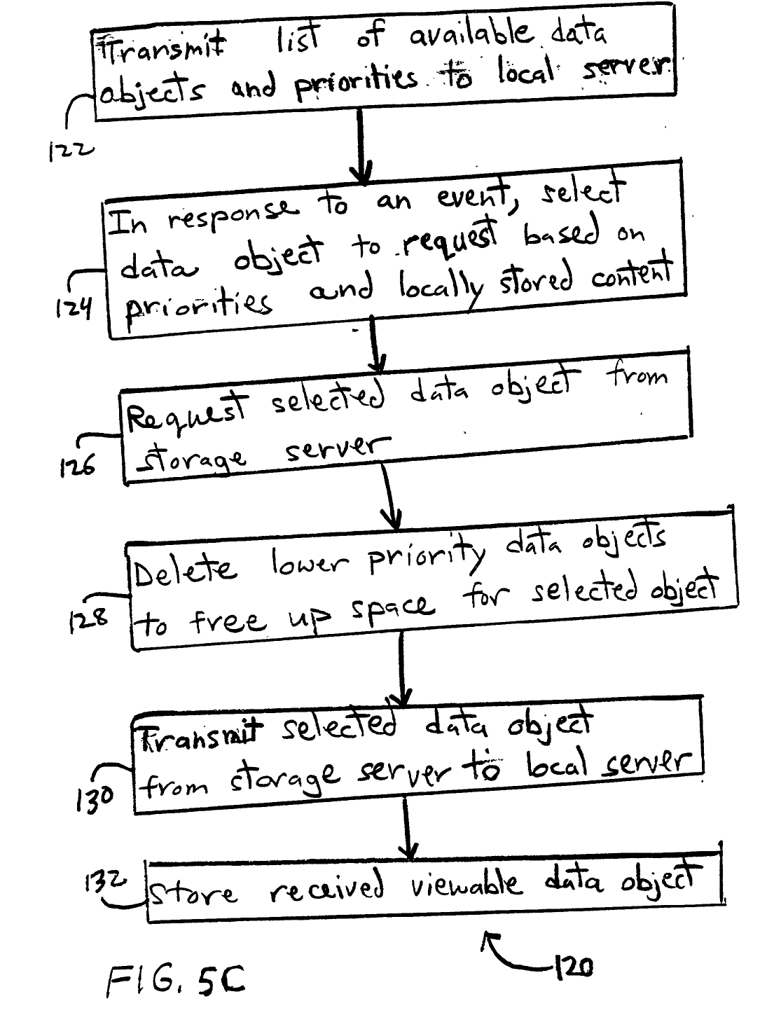

FIG. 5A is a flow chart illustrating an automated method 96 for distributing a new viewable data object through the transmission network 38 of FIG. 3. The central manager 39 transmits the new data object to all storage servers 43, 44 over the network lines 41, 42 (step 97). The storage servers 43, 44 automatically transmit the new data object to the local servers 45-49, in response to priorities, for example, expected or actual viewer demand (step 98). Finally, the local servers 45-49 and storage servers 43, 44 transmit the new data object to the local televisions 62-69 in response to viewer requests (step 99). The method 96 automatically distributes new data objects to the local servers 45-49 without “human” intervention, for example, to manually store the new data object to the individual servers 43-49.

FIGS. 5B and 5C illustrate, in more detail, first and second methods for distributing viewable data objects from the storage servers 43, 44 to associated local servers 4549.

FIG. 5B is a flow chart illustrating a method 100 of distributing viewable data objects to local server 45 based on a master-slave relationship. The local server 45 transmits to the storage server 44 operations data indicating the viewable data objects and/or available space in the local server 45 (step 102). In response to a preselected event, the storage server 44 selects a viewable data object to transmit to the local server 45 by using the above-described priorities and received operations data (step 104). The preselected event may be a time, a date, a special situation, or a control signal from the manager 39 calling for distribution. The storage server 44 transmits the selected viewable data object and associated meta data to the local server 45 (step 106). The local server 45 receives the transmitted data object (step 108). The processor 94 stores the received data object on the storage device 90 of the local server 45 (step 110).

To store the received data object, the processor 94 may have to make space by deleting data objects of lower priority from the storage device 90. The received data object contains priority and size ratings, which the processor 94 uses in determining which data objects to delete. The processor 94 deletes the lowest priority data objects to make space, if necessary, in the storage device 90.

FIG. 5C is a flow chart illustrating an alternate method 120 of distributing viewable data objects to the local servers 45-49 based on shared decision making. The storage server 44 transmits a list of available viewable data objects and priorities to, for example, the local server 45 (step 122). The list may include data objects already stored in the local server 45. In response to a preselected event, the local server 45 selects one or more viewable data objects to request from the storage server 44 based on priorities and the locally stored content of data objects (step 124). The preselected event may be a time, a date, a special occurrence, or a control signal from the manager 39. Next, the local server 45 requests the selected data object(s) from the storage server 44 (step 126). The local server 45 deletes, if necessary, enough lower priority viewable data objects from its storage device 90 to free up space for the new selected data object(s) (step 128). The storage server 44 transmits the selected data object(s) to the local server 45 in response to receiving the request (step 130). The local server 45 stores the received data object(s) in its storage device 90 (step 132).

In some embodiments, the manager 39 or the storage server 44 separately transmits to the storage and local servers 43-49 new priority ratings. These ratings affect the subsequent decisions to transmit and/or store viewable data objects to the local servers 45-49.

In accordance with the methods 96, 100, 120 of FIGS. 5A to 5C, the storage server 44 may transmit a group of viewable data objects as a unit instead of as individual viewable data objects. Similarly, the local server 45 may delete/store groups of viewable data objects as units instead of as individual viewable data objects.

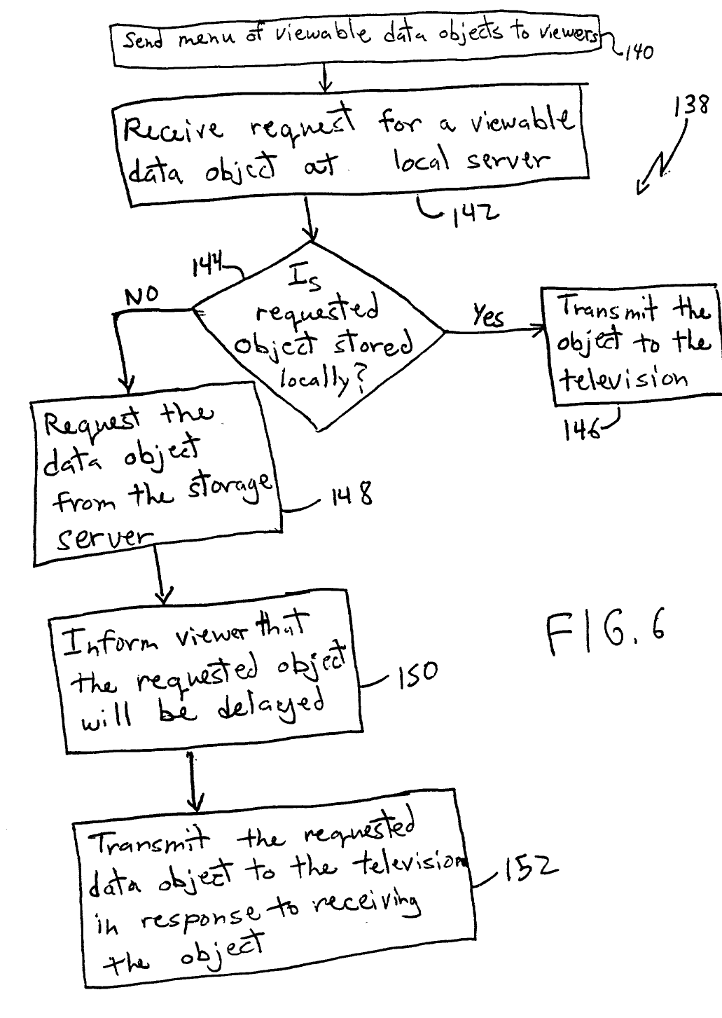

FIG. 6 is a flow chart illustrating a method 138 of processing a viewer request for a viewable data object. The local server 45 sends to the viewer a menu data object, listing available viewable data objects, for display on the televisions 64, 65 (step 140). A viewer can interactively review the menu object. The local server 45 can then receive a request for a data object from one of the local televisions 64, 65. (step 142). The local server 45 determines whether the requested object is stored in the local server 45 (step 144). The local server 45 transmits the requested object to the requesting television 64, 65 if the object is stored therein (step 146). Otherwise, the local server 45 requests the data object from the storage server 44 (step 148). The local server 45 also informs the viewer that the object will have a predetermined delay if the server 45 must request the object from the storage server 44 (step 150). The server 45 may display a delay message at the requesting television 64, 65 to indicate the delay. The local server 45 transmits the data object to the requesting television 64 when the local server 45 receives the object from the storage server 44 (step 152).

Additions, deletions, and other modifications of the described embodiments will be apparent to those practiced in this field and are within the scope of the following claims.

What is claimed is:

1. A network for transmitting viewable data objects, comprising:
a plurality of local servers to store subsets of the viewable data objects;
a plurality of links to couple each local server to a set of viewer receivers without coupling the viewer receivers together, each local server to transmit viewable data objects to viewer receivers; and
at least one storage server to store the viewable data objects and to transmit a subset of the stored data objects to the local servers responsive to different expected demands there present.

2. The network of claim 1, wherein the storage server is adapted to transmit data objects based on priorities determined by the local server identity and viewable data object content.

3. The network of claim 1, wherein each local server is adapted to transmit viewable data objects to a plurality of viewer televisions.

4. The network of claim 1, wherein each local server is capable of deleting a first viewable data object to free space to store a new viewable data object in response to the priority for the new object being higher than the priority for the first viewable data object.

5. The network of claim 1, further comprising:
a plurality of second local servers to store subsets of the viewable data objects;
a plurality of second links to couple each second local server to a distinct set of second viewer receivers without coupling the second viewer receivers together, each second local server to transmit viewable data objects to second receivers; and
a second storage server to store the viewable data objects and to transmit a subset of the stored data objects to the second local servers responsive to different expected demands there present; and
a hardware manager to automatically distribute new viewable data objects to the first and second storage servers.

6. The network of claim 1, wherein the storage server is capable of transmitting a group of viewable data objects to each local server as a single unit and the local servers are capable of storing and of later deleting the group of viewable data objects as a single unit.

7. The network of claim 6, wherein the network manager is adapted to control work queues for data objects stored on the local servers.

8. The network of claim 1, wherein the local servers support restricted viewer streaming control, access to viewer streaming control being restricted based on one of events, locality, and content of data objects.

9. A network for transmitting viewable data objects interactively, comprising:
a plurality of local servers to store subsets of the viewable data objects;
a plurality of lines to couple each local server to a set of viewer receivers without coupling viewer receivers together, each local server to transmit a viewable data object to a viewer receiver in response to receiving a request therefrom; and
at least one storage server to store the viewable data objects and to transmit a subset of the stored data objects to the local servers responsive to different expected demands there present.

10. The network of claim 9, wherein the storage server is adapted to transmit particular data objects to particular local servers based on priorities determined by the identity of the particular local servers and the content of the particular data objects.

11. The network of claim 9, wherein a portion of the priorities can be dynamically updated by events.

12. The network of claim 9, wherein each local server is adapted to transmit viewable data objects to a plurality of interactive viewer televisions.

13. The network of claim 9, wherein the local servers support streaming control of viewable data objects by viewers, said control being restricted based on one of events, locality, and content of data objects.

14. The network of claim 9, wherein each local server is capable of deleting a first viewable data object to free space to store a new viewable data object if the priority for the new object is higher than the priority for the first viewable data object.

15. The network of claim 9, further comprising:
a plurality of second local servers to store subsets of the viewable data objects;
a plurality of second lines to couple each second local server to a set of second viewer receivers without coupling the viewer receivers together, each second local server to transmit a viewable data object to a second receiver in response to receiving a request therefrom; and
a second storage server to store the viewable data objects and to transmit a subset of the stored data objects to the second local servers responsive to different expected demands there present; and
a hardware manager to automatically distribute new viewable data objects to the first and second storage servers.

16. The network of claim 15, wherein the hardware manager is adapted to transmit meta data to the local servers and to update meta data stored on the local servers.

17. The network of claim 9, wherein the viewable data objects include video data objects and game data objects.

18. The network of claim 9, wherein the storage server is capable of transmitting a group of viewable data objects to each local server as a single unit and the local servers are capable of storing and later deleting the group of data objects as a single unit.

19. The network of claim 9, wherein the network manager is adapted to control work queues for data objects stored on the local servers.

20. A cable television network, comprising:
a plurality of servers to transmit viewable data objects to different viewer televisions, each server to transmit a viewable data object to one of the televisions in response to a request from the one of the televisions; and
a device to transmit viewable data objects to each of the local servers, the device capable of transmitting different data objects to the different local servers.

21. The network of claim 20, wherein the servers form a star-shaped network about the device.

22. The network of claim 20, wherein the device transmits data objects based on events and priorities attached to the local servers and to the content of data objects.

23. The network of claim 20, wherein the servers support restricted viewer streaming control, access to viewer streaming control being restricted based on one of events, locality, and content of data objects.

24. The network of claim 20, further comprising a hardware manager to automatically distribute new viewable data objects to the local servers.

25. The network of claim 24, wherein the manager is adapted to control work queues for data objects stored on the servers.

26. A method of distributing viewable data objects to viewer receivers, comprising:
selecting a first viewable data object from a pool of viewable data objects in response to a preselected event;
selecting a second viewable data object from the pool in response to a preselected event;
transmitting the first and second objects to respective first and second local servers, the first and second objects being responsive to different priorities of the respective first and second local servers for data object content;
sending a data object from the first local server to a first viewer receiver; and
sending a data object from the second local server to a second viewer receiver.

27. The method of claim 26, wherein the acts of sending are in response to requests from the viewer receivers.

28. The method of claim 26,
wherein the acts of selecting are based, in part, on operations data received from the local servers.

29. The method of claim 26, further comprising:
sending a list of available data objects to the first local server; and
wherein the selecting a first viewable data object is responsive to receiving the list and to priorities for data object content at the first local server.

30. The method of claim 26, further comprising:
receiving a request for a viewable data object from the first viewer receiver; and
wherein selecting a first data object is responsive to receiving the request from the first viewer receiver.

31. The method of claim 26, further comprising:
transmitting meta data from a central manager to the local servers; and
receiving a request for a viewable object from a viewer's receiver in response to streaming a portion of the meta data on the viewer's receiver.

32. The method of claim 26, wherein the act of
selecting includes calculating a delay with operations data from the first server; and
wherein transmitting a first object is performed after the delay ends; and further comprising:
storing a portion of the first object in storage space of the first server freed at the end of the delay.

33. A network to provide viewable data objects to television viewers interactively, comprising:
a plurality of local servers to store viewable data objects, each local server to transmit viewable data objects to a distinct and different set of televisions, each local server to transmit a viewable data object to one of the televisions in response to receiving a request from the one of the televisions; and
a storage server coupled to distribute data objects to the local servers, the storage server being responsive to actual and expected demands of the sets of televisions connected to each different local server.
